(19) United States
(12) Patent Application Publication
(10) Pub. No.: US 2011/0204221 A1
(43) Pub. Date: Aug. 25, 2011

(54) MASS SPECTROMETER AND METHOD OF MASS SPECTROMETRY

(76) Inventors: Hiroyuki Satake, Tokorozawa (JP); Masuyoshi Yamada, Ichikawa (JP)

(21) Appl. No.: 13/122,418

(22) PCT Filed: Oct. 8, 2009
(86) PCT No.: PCT/JP2009/067558

§ 371 Date: Apr. 4, 2011

(30) Foreign Application Priority Data
Oct. 14, 2008 (JP) 2008-264749

(51) Int. Cl. H01J 49/26; H01J 49/40

(52) U.S. Cl. 250/282; 250/288; 250/287

(57) ABSTRACT

When a high-speed analyzer such as a quadrupole mass filter is united with an analyzer which requires a reaction time of 10 msec, such as an ion dissociation chamber of the ion trap type, a problem arises that an ion loss occurs due to a difference in analysis speed between the analyzers. A high-throughput analysis is intended to be achieved by eliminating this loss. A pre ion trap (4) is provided between a quadrupole filter (3) and an ion dissociation chamber (5), and ions are accumulated in the pre ion trap (4) while operations such as dissociation, isolation and ejection are being performed in the ion dissociation chamber (5). This configuration solves a problem with the ion dissociation chamber (5), which is a decrease in transmittance of the dissociation chamber (5), i.e., a decrease in throughput, and accordingly enables a high-throughput structural analysis on a measurement sample.

### TECHNICAL FIELD

The present invention relates to a method of mass spectrometry and a mass spectrometer.

### BACKGROUND ART

In mass spectrometry, a mass-to-charge ratio m/z (m: mass, z: number of charges) of target molecular ions is measured by: either ionizing sample molecules and introducing the sample molecular ions into a vacuum, or ionizing the sample molecules in a vacuum; and thereafter by measuring the motion of the sample molecular ions in an electromagnetic field. Since the obtained information is about the mass-to-charge ratio m/z, it is difficult to obtain information on the inner structure. For this reason, a method termed as tandem mass spectrometry is used. In the tandem mass spectrometry, sample molecular ions are specified or selected in the first mass analysis operation. The selected ions are called precursor ions. Subsequently, the precursor ions are dissociated in the second mass analysis operation by use of a given technique. The dissociated ions are called fragment ions. Then, the sequence structure of the precursor ions can be estimated by performing a mass spectrometry on the fragment ions.

Having dissociation patterns following their own specific laws, the dissociation techniques enable the estimation of the sequence structure of the precursor ions. The field of analysis of biomolecules having proteins as their skeletons, in particular, employs, as the dissociation techniques, charged-particle reactions using collision induced dissociation (CID), infrared multi-photon dissociation (IRMPD), electron capture dissociation (ECD), electron transfer dissociation (ETD), proton transfer charge reduction (PTR), and fast atomic bombardment (FAB).

In the field of the protein analysis, CID is a widely-used ion dissociation technique. Precursor ions are given kinetic energy and thereby are caused to collide with a buffer gas of He or the like introduced in a dissociation chamber. The collision induces molecular vibrations, and ions are thus dissociated at sites of the molecular chain which are susceptible to cleavage. Meanwhile, in IRMPD, precursor ions are irradiated with an infrared laser beam, and are made to absorb a large number of photons. This induces molecular vibrations, and ions are dissociated at sites of the molecular chain which are susceptible to cleavage. The sites susceptible to cleavage by CID and IRMPD are sites designated as a-x and b-y in the main chain consisting of amino acid sequence. It is known that a complete structural analysis cannot be carried out only by CID or IRMPD since even the a-x and b-y sites are sometimes hard to cleave depending on the kind of amino acid sequence pattern. For this reason, a pretreatment using enzyme or the like is necessary, but such a pretreatment hinders a fast analysis. Further, when CID or IRMPD is used for biomolecules having undergone a post-translational modification, side chains involved in the post-translational modification (modification molecules) tend to be susceptible to cleavage. Since the side chains are susceptible to cleavage, it is possible to determine on the basis of the lost mass what molecular species is involved in the modification, and whether or not the molecules are modified. However, important information on modification sites concerning which amino acid sites are modified is lost.

On the other hand, ECD, ETD and the like, which are dissociation techniques using electrons as an alternative dissociation means, are less dependent on amino acid sequence (as an exception, proline residue with a cyclic structure is not cleaved), and cleave only one c-z site on the main chain of the amino acid sequence. Accordingly, the main chain sequences of protein molecules can be analyzed by use of only a mass spectrometric technique. In addition, ECD and ETD are suitable as a means for research and analysis of post-translational modification owing to their characteristic of having side chains hard to cleave. For those reasons, the dissociation techniques, ECD and ETD, have been attracting particular attention in recent years. CID, IRMPD, ECD, and ETD can be used complementarily, because they provide pieces of sequence information that differ from one another.

The tandem mass spectrometry is widely used in mass spectrometers using an ion trap or a quadrupole, such as an ion trap mass spectrometer, an ion trap TOF (time-of-flight) mass spectrometer, a triple quadrupole mass spectrometer, and a quadrupole TOF mass spectrometer. The ion trap allows a tandem mass spectrometry multiple times, enabling an analysis of a sample whose sequence structure cannot be analyzed if a tandem mass analysis operation is performed only once. In the ion trap, the trajectories of ions are converged by applying a radio frequency voltage to a ring electrode or multipole rods (cylinder electrodes) in a three-dimensional ion trap. The quadrupole ion trap mass spectrometer includes: a Paul trap formed from a ring electrode and a pair of endcap electrodes; a linear quadrupole ion trap formed from four cylinder electrodes; or the like. When a radio frequency voltage having a frequency of about 1 MHz is applied to the ring electrode or the cylinder electrodes, ions in a certain mass range are put into a stabilized condition, and thereby can be accumulated. The triple quadrupole mass spectrometer and the quadrupole TOF mass spectrometer both include a quadrupole mass filter in a stage preceding the ion dissociation unit. The quadrupole mass filter plays a role of transmitting only ions having a specific mass-to-charge ratio and rejecting the other ions. Moreover, ions which the filter transmits can be changed from one kind to another by scanning the mass-to-charge ratio of ions to be transmitted.

Patent Documents 1 and 2 describe ECD methods performed in a radio frequency three-dimensional ion trap and a radio frequency linear quadrupole ion trap. A proposal is made on ECD methods in which: a magnetic field is applied to an ion trajectory in the three-dimensional ion trap and the linear ion trap; the trajectories of electrons are restricted by the magnetic field; and the heating of the electrons is avoided. For the configuration using the three-dimensional ion trap, a proposal has been made on a method in which: a magnet is disposed inside a ring electrode or outside end caps; and electrons are introduced from the outside of the ion trap. Moreover, for the configuration using the linear ion trap, descriptions are provided for a method in which: a magnetic field is applied to the center axis of the linear ion trap; and electrons are introduced onto the ion trajectory from the inside of the magnetic field.

Patent Document 3 describes an ECD method performed inside a radio frequency linear quadrupole ion trap. Descriptions are provided for the ECD method in which: a magnetic field is applied to an ion trajectory in the linear quadrupole ion trap; the trajectories of electrons are restricted; and the heating of the electrons attributable to a radio frequency voltage is avoided.

Patent Document 4 describes a configuration in which in a quadrupole to which a radio frequency voltage is applied, multipole rod electrodes disposed in an ion dissociation chamber or the like are tilted, or tilted electrodes are inserted between the multipole rod electrodes. With this configuration, an electrostatic field which urges ejection of ions toward the exit is generated on the center axis of the multipole, and thereby, the time needed to eject ions is decreased. Descriptions are provided for the apparatus configuration in which a mass filter and a quadruple ion dissociation chamber are connected together.

Patent Document 5 describes a triple quadrupole mass spectrometer system including an ion source, an ion trap (pre ion trap) configured to only accumulate ions, a quadrupole mass filter, an ion dissociation chamber, and an ion trap capable of mass-based selective ejection, the system in which sample ions coming out of the ion source are accumulated in the pre ion trap while an ion ejection operation is being performed in the ion trap capable of mass-based selective ejection.

### PRIOR ART DOCUMENT

### Patent Document

Patent Document 1: U.S. Pat. No. 6,800,851 B1
Patent Document 2: U.S. Pat. No. 6,958,472
Patent Document 3: JP 2005-235412 A
Patent Document 4: U.S. Pat. No. 5,847,386
Patent Document 5: U.S. Pat. No. 6,177,668

### SUMMARY OF THE INVENTION

### Problem to be Solved by the Invention

Dissociation chambers include those of a non-ion-trap type and those of an ion-trap type. The non-ion-trap type has an advantage of achieving high throughput, but has a disadvantage of being incapable of a tandem mass spectrometry (MS/MS). On the other hand, the ion-trap type has a disadvantage of having low throughput, but has an advantage of being capable of adjust the dissociation reaction time freely, and performing a tandem mass spectrometry.

Non-ion-trap type ion dissociation chambers are used in triple quadrupole mass spectrometers and quadrupole TOF mass spectrometers. Triple quadrupole mass spectrometers are widely used for their capabilities to perform a high-throughput analysis and a quantitative analysis using a precursor scan and a neutral loss scan. Quadrupole TOF mass spectrometers are also widely used for their capabilities to perform a high-throughput analysis. For the ion dissociation chamber, CID or IRMPD has been widely used as the ion dissociation method. However, for the purpose of improving the efficiency in analyzing proteins, new ion dissociation methods such as ECD and ETD are expected to be employed in the future. Triple quadrupole mass spectrometers and quadrupole TOF mass spectrometers both include a quadrupole mass filter in a stage preceding the ion dissociation chamber. This quadrupole mass filter plays a role of transmitting only ions having a specific mass-to-charge ratio m/z and rejecting the other ions. The ions of the specific m/z passed through the mass filter enter the ion dissociation chamber, where an ion dissociation reaction operation is performed. Patent Document 4 states that time needed to eject ions is shortened by urging ion ejection in a non-ion-trap type dissociation chamber by means of slope electrodes.

Instead of a non-ion-trap type ion dissociation chamber, however, an ion-trap type ion dissociation chamber needs to be used when the reaction time needed for the ion dissociation is longer than 1 ms, or when a tandem mass spectrometry is intended to be performed multiple times. Patent Document 3 describes an ECD operation method performed in an ion-trap type dissociation chamber using a linear quadrupole ion trap. For the method, the ion-trap type ion dissociation chamber capable of securing a certain reaction time is used because the dissociation reaction time in ECD needs to be about 1 ms or longer. Meanwhile, a device termed as a travelling wave (a travelling-wave type dissociation chamber) has emerged in recent years. The device has a configuration in which multiple electrodes are aligned together, and is capable of adjusting the ion ejection rate by applying a DC electric field to a center axis. Unlike the ion-trap type dissociation chamber, this travelling-wave type dissociation chamber is not capable of performing a tandem mass spectrometry. However, like the ion-trap type dissociation chamber, the travelling-wave type dissociation chamber is capable of securing a certain ion reaction time.

The following problem occurs, nevertheless, in the case of a configuration where the ion-trap type or travelling-wave type ion dissociation chamber is installed in a stage following the quadrupole mass filter. Description is given below by taking the ion-trap type ion dissociation chamber as an example, but a similar problem will also occur in the travelling-wave type ion dissociation chamber. The quadrupole mass filter sequentially ejects only specific ions selected from incident ions. The time period in which ions stay inside the quadrupole mass filter is approximately 1 ms or shorter. Meanwhile, the ion dissociation chamber at the following stage operates with a cycle of ion accumulation, ion dissociation, and ion ejection in a normal tandem mass analysis operation. One cycle normally requires 10 msec or more. The difference in the ion stay time between the quadrupole mass filter and the ion dissociation chamber results in an ion loss.

Descriptions will be provided for an operation of the ion-trap type ion dissociation chamber and a problem with the ion-trap type ion dissociation chamber. Ions are supplied at a steady rate from the ion source to the quadrupole mass filter in the stage preceding the ion dissociation chamber. In contrast, the ions are allowed to enter the ion dissociation chamber, and are accumulated therein. Then, the dissociation chamber closes the gate by applying a voltage to an entry gate electrode, and thereby blocks the entry of the ions. Thereafter, operations of ion isolation, ion dissociation, and then ejection of the resultant ions for sending the ions to a detector are performed. The entry of ions into the ion dissociation chamber is not allowed during the ion isolation, ion dissociation, and ion ejection. Hence, ions from the ion source are discarded immediately before the ion dissociation chamber although passed through the quadrupole mass filter. This causes an ion loss. To be specific, in the one cycle operation in the ion dissociation chamber, ions can enter the ion dissociation chamber only during the accumulation, but cannot enter the ion dissociation chamber during any other time, i.e., the isolation, dissociation, or ejection time. Thus, ions coming out of the ion source during those other times have to be discarded. In this respect, the ratio of the accumulation time to a time needed for the one cycle (accumulation, isolation, dissociation, and ejection) is defined as transmittance of the ion dissociation chamber. A higher transmittance means a higher efficiency, and a lower transmittance means a greater ion loss. In the case where the accumulation, dissociation, and ejection respectively require 20 msec, 15 msec, and 5 msec in one tandem mass spectrometry, the transmittance is 50% (20/40).

Further, in a case where a tandem mass spectrometry is to be performed multiple times, that is, operations of ion dissociation, ion isolation, dissociation, ion isolation, dissociation, and ion isolation are to be performed in turn, or in a case where the dissociation time is as long as tens msec to over 100 msec as in ECD, ETD or the like, the time during which ions cannot enter there (time periods of dissociation, isolation, and ejection) becomes even longer, and thereby the amount of ion loss becomes larger. As a result, if the dissociation time exceeds, for example, 100 msec in the case described above, the transmittance falls to 20% or lower.

For the purpose of solving a problem of the ion loss, Patent Document 5 describes a configuration in which: the pre ion trap is disposed before the ion dissociation chamber to prevent an ion loss during the mass-based selective ejection. In this device configuration, however, a large variety and a large amount of ions obtained by ionization in the ion source are stored in the pre ion trap. Once the amount of stored ions exceeds its accumulation capacity, the trap cannot trap any more ions. For this reason, it is expected to be difficult to store a large amount of ions from the ion source in the pre ion trap for a long period of time. In other words, in the case of requiring a long ion dissociation time or using a highly-concentrated sample, it is expected that an ion loss still occurs and the problem cannot be fully solved even if the pre ion trap of Patent Document 5 is used.

### Means for Solving the Problem

For the purpose of solving the above-described problem, a mass spectrometer of the invention is characterized by including: an ion source for ionizing a sample; a mass filter, disposed at a stage following the ion source, for selectively transmitting ions falling within a specific mass number range; an ion trap unit, disposed in a stage following the mass filter, for accumulating ions; an ion dissociation unit, disposed at a stage following the ion trap unit, for accumulating ions and dissociating the ions thus accumulated; a detection unit, disposed at a stage following the ion dissociation unit, for detecting ions; and a controller for controlling the ion accumulation and ion ejection in the ion trap unit in accordance with an operation of the ion dissociation unit.

The controller causes the ion trap unit to accumulate ions passed through the mass filter, except while the ion dissociation unit is accumulating ions, or while the controller is applying a voltage to an electrode for controlling the entry of the ions into the ion dissociation unit in order to block the ions from entering the ion dissociation unit.

In addition, a method of mass spectrometry of the invention characterized by including the steps of: ionizing a sample; selecting first ions having a specific mass number range from the ions thus generated; accumulating the selected first ions in an ion dissociation unit; dissociating the first ions in the ion dissociation unit, and accumulating second ions having a specific mass number range in an ion trap unit provided at a stage preceding the ion dissociation unit; ejecting fragment ions generated by dissociating the first ions; detecting the ejected fragment ions, and accumulating the second ions, accumulated in the ion trap unit, in the ion dissociation unit; ejecting fragment ions generated by dissociating the second ions; and detecting the ejected fragment ions.

### Effects of the Invention

According to the disclosure concerned, it is possible to prevent an ion loss which may occur when connecting a quadrupole mass filter and an ion-trap type ion dissociation chamber, and thus to make the transmittance of the ion dissociation chamber closer to 100%. Accordingly, a high-throughput analysis can be achieved.

In a case where a long reaction time of 10 ms or longer is needed as in an ion dissociation reaction such as ECD or ETD, the conventional method makes an ion loss larger as the ion reaction time becomes longer; however, the disclosure concerned hardly causes the ion loss even when the reaction time is increased. As a result, the reaction time can be increased freely, whereby the dissociation reaction can be performed in an optimal reaction time depending on the dissociation method. Furthermore, in a case where an operation time of the dissociation chamber similarly becomes longer due to the multiple repetition of a tandem mass spectrometry, the conventional method resultantly loses ions; however, the disclosure concerned causes no ion loss no matter how many times the tandem mass spectrometry is performed in the ion dissociation chamber. The disclosure concerned is effective when devices having mutually different ion transmission rates are united together as in the case of a configuration where a quadrupole mass filter and an ion-trap type ion dissociation chamber are united together.

Moreover, the device configuration prevents an ion loss which is not expected to be solvable completely even by use of Patent Document 5, and is very effective when the ion dissociation time is desired to be made longer or when a highly concentrated sample is used.

As described above, the disclosure concerned can solve a problem with the ion-trap type and travelling-wave type ion dissociation chambers, which is the decrease in transmittance of the ion dissociation chamber, i.e., the decrease in throughput. Accordingly, the disclosure concerned can increase throughput of a structural analysis on a measurement sample.

### BRIEF DESCRIPTION OF THE DRAWINGS

FIG. 1 is a diagram for describing an embodiment of a mass spectrometer including a quadrupole mass filter, a pre ion trap, an ion dissociation chamber, and TOF mass spectrometers.

FIG. 2 is a flow chart of a mass spectrometry in the disclosure concerned.

FIG. 3 is a diagram for describing an operation sequence of an ion dissociation chamber and wall electrode sequences in the disclosure concerned.

FIG. 4 is a diagram for describing an operation sequence of an ion dissociation chamber and wall electrode sequences in a conventional case.

FIG. 5 is a diagram for describing another embodiment of the mass spectrometer including the quadrupole mass filter, the pre ion trap, the ion dissociation chamber, and the TOF mass spectrometer.

FIG. 6 is a diagram for describing yet another embodiment of the mass spectrometer including the quadrupole mass filter, the pre ion trap, ion dissociation chambers, and the TOF mass spectrometer.

FIG. 7 is a diagram for describing the other embodiment of the mass spectrometer including the quadrupole mass filter, the pre ion trap, ion dissociation chambers, and the TOF mass spectrometer.

### MODES FOR CARRYING OUT THE INVENTION

A mass spectrometer of the present invention is capable of effectively using ions and accordingly performing a high-throughput analysis by accumulating ions, which would otherwise conventionally lose during ion dissociation, isolation and ejection times, in a pre ion trap by use of its configuration in which a mass filter, an ion trap (pre ion trap), and an ion-trap type ion dissociation chamber(s) are connected together in series.

### Embodiment 1

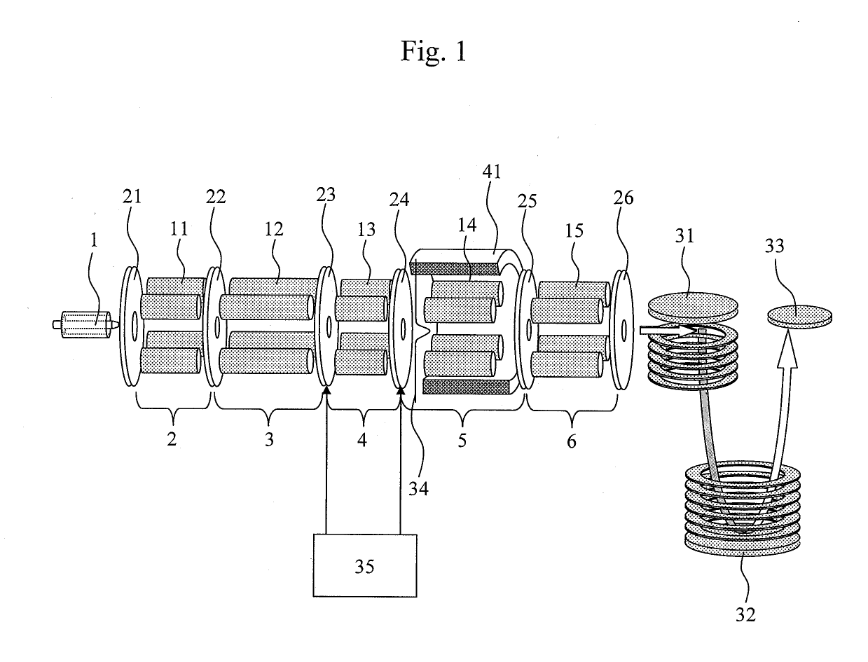

FIG. 1 is a diagram for describing an embodiment of a mass spectrometer including a quadrupole mass filter, a pre ion trap, an ion dissociation chamber, and TOF mass spectrometers. The flow in the mass spectrometer is as follows. An analysis target sample separated by a liquid chromatograph or the like is ionized in an ion source 1. The sample ions obtained by the ionization pass a linear quadrupole ion guide unit 2, a quadrupole filter 3 and a pre ion trap 4 inside a vacuum device. Thereafter, the sample ions enter an ion dissociation chamber 5, and are dissociated there. The fragment ions obtained by the dissociation are measured by TOF mass spectrometers 31 to 33, whereby a mass spectrum is obtained.

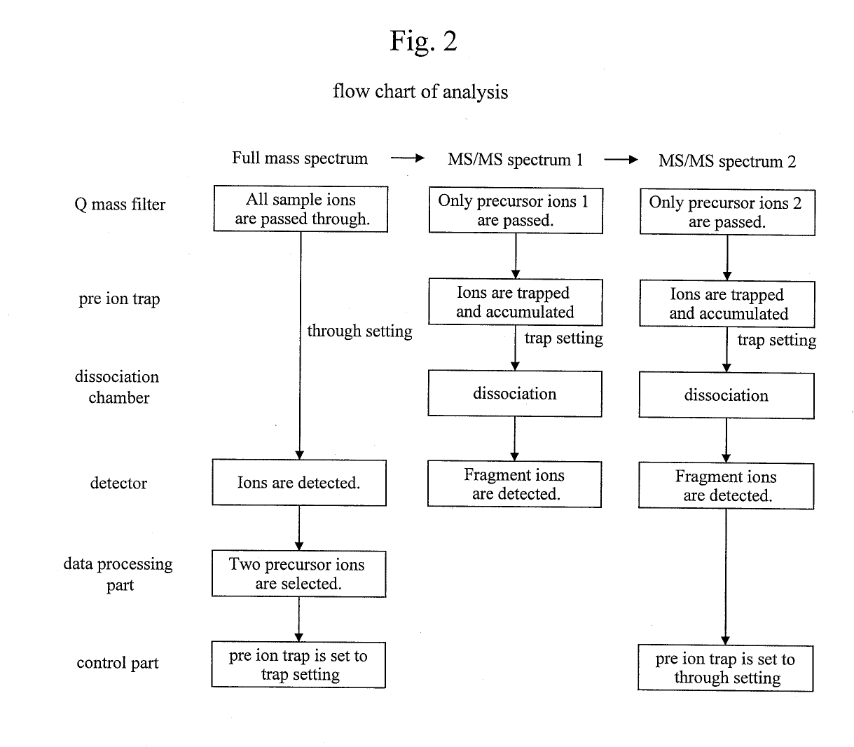

FIG. 2 describes a flow chart of an analysis. In this embodiment, a full mass spectrum is acquired, from which two kinds of precursor ions are determined as structural analysis targets. Thereafter, two MS/MS spectra are acquired by dissociating the precursor ions. After that, data are acquired by repeating the acquisition of the full mass spectrum and the two MS/MS spectra until the sample introduction is completed. When either the full mass spectrum or the two MS/MS spectra are acquired, ions are caused to pass the ion source 1 through the TOF mass spectrometers 31 to 33 without loss by gently lowering the potential from the ion source 1 toward the TOF mass spectrometers 31 to 33. In the case of positive ions, a DC voltage is gradually lowered from the foremost to rearmost stages. Conversely, in the case of negative ions, the voltage is increased gradually.

In order to acquire the full mass spectrum, first of all, the quadrupole mass filter 3, the pre ion trap 4, and the ion dissociation chamber 5 are first set up such that all the ions can pass them. The ions passed through them are converged on a center axis in a collisional-damping chamber 6, and then the flight time of the ions is measured by the TOF mass spectrometers 31 to 33. Thereby, the full mass spectrum is acquired. From the full mass spectrum, two kinds of precursor ions are selected. Subsequently, the pre ion trap 4 is operated as described below, and the MS/MS spectra are acquired.

In order to acquire the MS/MS spectra, the quadrupole mass filter 3 allows only ions (precursor ions 1 or 2) having a specific, selected mass-to-charge ratio (m/z) to pass the quadrupole mass filter 3, and rejects ions having any other m/z. The ions passed through it enter the pre ion trap 4, and are accumulated there. The ions ejected from the pre ion trap 4 enter the ion dissociation chamber 5, and are subjected to a dissociation reaction operation such as CID or ECD. The fragment ions generated by the dissociation are detected by the detection system. The MS/MS spectra are acquired by repeating the above procedure one or more times. If a full mass spectrum is to be acquired again after obtaining the MS/MS spectra, the pre ion trap 4 is set up such that all the ions can pass the pre ion trap 4.

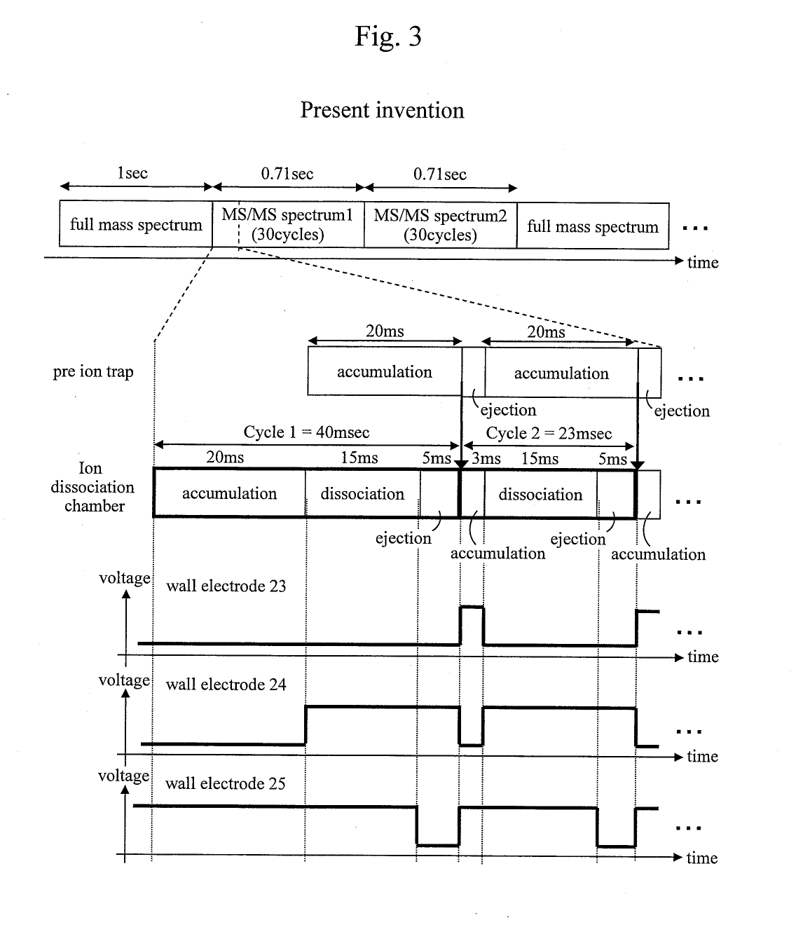

Using FIG. 3, description is given of a method of operating the pre ion trap 4 and the ion dissociation chamber 5 in order to acquire the MS/MS spectra, which represents details of the disclosure concerned. In FIG. 3, a top section shows a measurement sequence in the mass spectrometry; a middle section, operation sequences of the pre ion trap 4 and the ion dissociation chamber 5; and a bottom section, voltage sequences of wall electrodes 23, 24, 25 provided in the two ends of each of the pre ion trap 4 and the ion dissociation chamber 5. In the pre ion trap 4, two operations of ion accumulation and ion ejection are performed as described in the middle section of FIG. 3. In the ion dissociation chamber 5, operations of ion accumulation, ion dissociation and ion ejection are performed for each tandem mass spectrometry. In this respect, a set consisting of the ion accumulation, ion dissociation and ion ejection is repeated 30 times, and the results thereof are integrated to acquire the MS/MS spectra of the fragment ions.

A role of the pre ion trap 4 is to accumulate ions, which are discarded while the dissociation and ejection are performed in the ion dissociation chamber, in the pre ion trap 4. As shown in the middle section of FIG. 3, the pre ion trap 4 accumulates ions, except while the ion dissociation chamber 5 is accumulating ions (i.e., while the ion dissociation chamber 5 is performing the dissociation, ejection, and isolation operations). Thereby, the ion loss is suppressed. In other words, the ion loss can be minimized if the ions are always accumulated in either the pre ion trap 4 or the ion dissociation chamber 5.

Description is given of the operation sequences of the voltages of the wall electrodes 23, 24, 25 shown in the bottom section of FIG. 3. Shown are voltage sequences which are followed by the wall electrodes in the case where the analysis sample ions have positive charges. In the case where the sample ions have negative charges, the voltage sequences may be figured out by reversing the polarities of DC voltages of the wall electrodes. When the pre ion trap 4 or the ion dissociation chamber 5 accumulates ions, i.e., when ions are intended to pass the wall electrode 23, the DC voltage of the wall electrode 23 is set low so that the ions can pass the wall electrode 23. Only for the purpose of ejecting the ions from the pre ion trap 4, the ions are urged to be ejected by setting the voltage high. When the ion dissociation chamber accumulates ions, i.e., when the pre ion trap 4 performs ejection, the DC voltage of the wall electrode 24 is set low to allow entry of the ions. When the ion dissociation chamber 5 performs dissociation or ejection, i.e., when the pre ion trap 4 performs accumulation, the DC voltage is set high to block the entry of the ions. Only at the time of ejecting the ions from the ion dissociation chamber 5, the DC voltage of the wall electrode 25 is set low to eject the ions; otherwise, the voltage is set high so that the ions cannot be ejected.

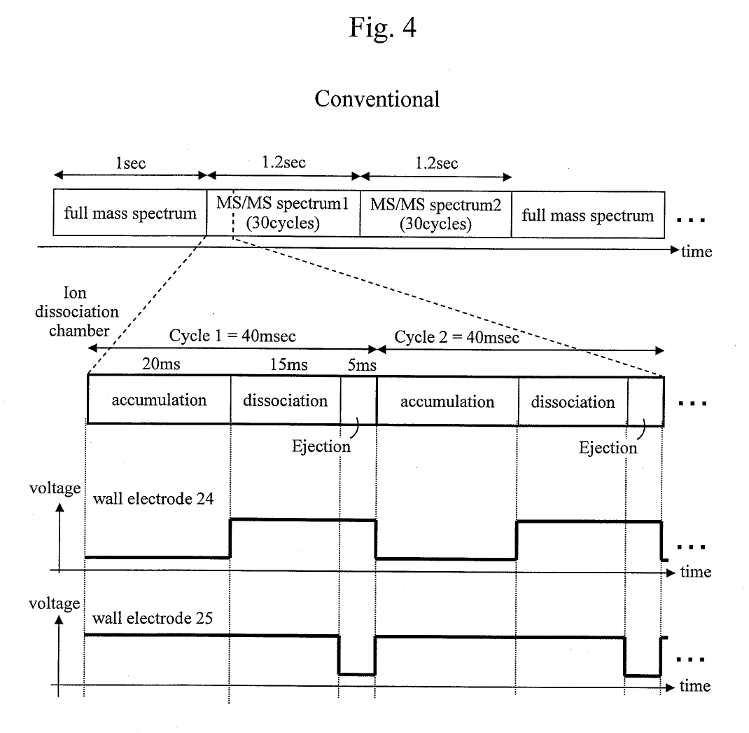

In the method of the disclosure concerned, a certain amount of ions is already accumulated in the pre ion trap 4 during dissociation. Thus, unlike the conventional method, such a long accumulation time as 20 ms does not needs to be spent to accumulate a sufficient amount of ions in the ion dissociation chamber 5. Instead, only several milliseconds (3 ms in FIG. 3), that is, the time needed to transport the ions from the pre ion trap 4, are sufficient. In other words, the accumulation time of the ion dissociation chamber 5 can be shortened while the same amount of ions as that of the conventional method is secured. Accordingly, though 40 ms is needed for the first cycle, the cycle time of the ion dissociation chamber 5 needed for each of the second to 30th cycles can be shortened to 23 ms from 40 ms needed in the conventional method. Thereby, a high-throughput analysis is feasible. In the disclosure concerned, the MS/MS spectra can be acquired in 0.71 sec in the 30-cycle example in FIG. 3. On the contrary, it takes approximately 1.2 sec for the conventional method to acquire the same MS/MS spectra, as shown in FIG. 4.

In the meanwhile, the transmittance per unit time (the ratio of the ions to be used in the analysis to the ions from the ion source: accumulation time/1 cycle time) of the ion dissociation chamber 5 of the disclosure concerned is 87% (20/23). The transmittance of the ion dissociation chamber in the conventional method is 50% (20/40), as mentioned previously (FIG. 4). In a case where a tandem mass spectrometry is to be performed multiple times, or in a case where an analysis using ECD or ETD, which needs a long dissociation time, is to be performed, the transmittance further decreases in the case of the conventional method, but the transmittance does not decreases when the disclosure concerned is used, as already mentioned in the section of Problem to be Solved by the Invention. As described above, with the disclosure concerned, the ions from the ion source can be accumulated in the pre ion trap 4 or the ion dissociation chamber 5 during almost the whole time. Accordingly, the ion loss can be minimized, and as a result, the transmittance of the ion dissociation chamber can be increased. This leads to the shortening of the time needed to acquire the MS/MS spectra, and therefore enables a high-throughput analysis.

In this embodiment, the collisional-damping chamber 6 and the TOF mass spectrometers are used at the stage following the ion dissociation chamber 5, but a detection system capable of acquiring mass spectra, such as an ion trap, a mass filter, an orbitrap, a Fourier-transform ion cyclotron resonance mass spectrometer or a magnetic sector mass spectrometer, may be used there. Also, the pre ion trap 4 and the ion dissociation chamber 5 are illustrated using quadrupole electrode rods as an example, but some other multipole electrode rods, such as hexapole electrode or octapole electrode rods, may be used for the pre ion trap 4 and the ion dissociation chamber 5. The reaction to be performed in the ion dissociation chamber may be an ion reaction or a charged-particle reaction such as CID, ECD, ETD or IRMPD. In the case of performing ECD, an electron source such as a filament may be placed on a center axis that is slightly off the ion trajectory.

The pre ion trap 4 is placed at the stage following the quadrupole mass filter 3, but at the stage preceding the ion dissociation chamber 5. The pre ion trap 4 may be placed at a stage preceding the quadrupole mass filter 3. An advantage of placing the pre ion trap 4 after the quadrupole mass filter 3 as in the case of FIG. 1 is that, because only ions of a specific m/z passed through the quadrupole mass filter 3 are accumulated in the pre ion trap 4, a large amount of ions can be accumulated, and a high transmittance of ions can be achieved, as mentioned above.

### Embodiment 2

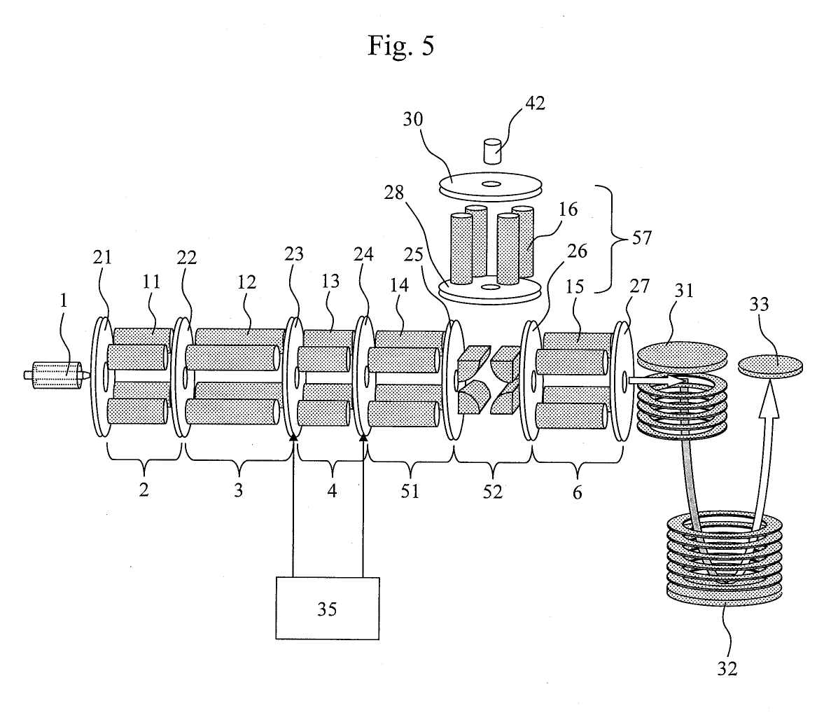

FIG. 5 is a diagram for describing another embodiment of the mass spectrometer including a quadrupole mass filter 3, a pre ion trap 4, and an ion dissociation chamber 51. This embodiment is a case where CID or ETD is carried out in the ion dissociation chamber 51. In the case of performing ETD, negative ions are generated in a negative ion source 42; the negative ions are subjected to isolation in a quadrupole filter 57; and the resultant ions are deflected by 90 degrees in a quadrupole deflector 52, and are introduced into the ion dissociation chamber 51. The quadrupole deflector 52, the quadrupole filter 57, and the negative ion source 42 may be inserted between the pre ion trap 4 and the ion dissociation chamber 51. The quadrupole filter 57 may be replaced with some other device as long as, like an ion trap, the device is capable of isolation. Furthermore, ECD can be carried out by: replacing the negative ion source 42 with an electron source; providing the ion dissociation chamber 51 with a permanent magnet; and introducing electrons from the electron source 42. In that case, it does not matter that the quadrupole filter 57 is not included. An operation method of accumulating ions in the pre ion trap 4 is basically the same as the operation method of Embodiment 1. Ions are accumulated in the pre ion trap 4 while the ion dissociation chamber 5 is not performing accumulation, i.e., while the ion dissociation chamber 5 is performing isolation, dissociation, ejection or the like.

As in the case of Embodiment 1, a detection system suffices if the mass spectrum can be acquired. Moreover, multipole electrode rods such as hexapole electrode rods or octapole electrode rods may be used for the pre ion trap 4 and the ion dissociation chamber 5.

### Embodiment 3

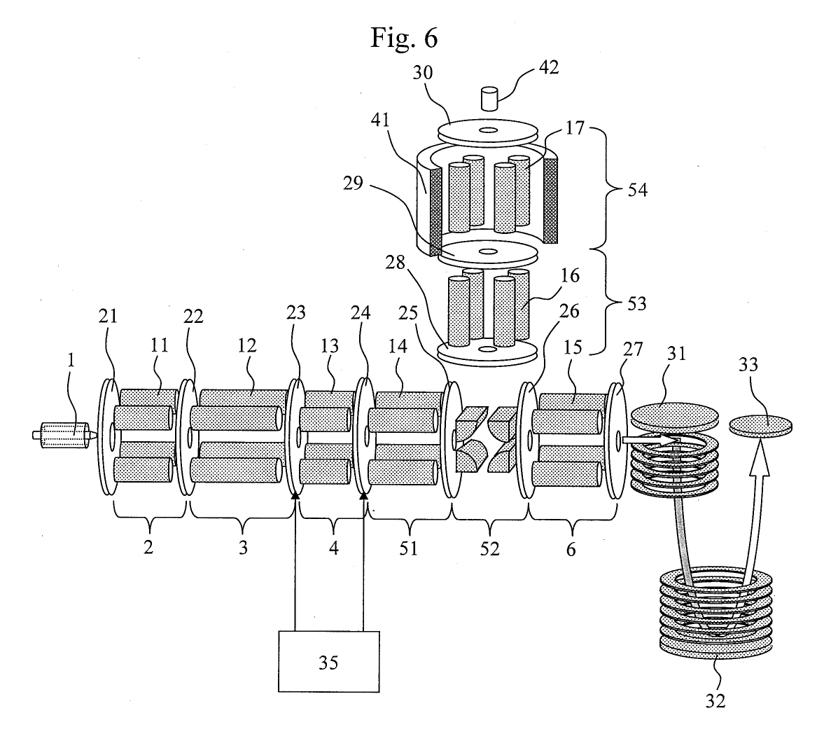

FIG. 6 is a diagram for describing yet another embodiment of the mass spectrometer including a quadrupole mass filter 3, a pre ion trap 4, and ion dissociation chambers 51, 54. This embodiment is a case where: CID is carried out in the ion dissociation chamber 51; and ECD is carried out in the ion dissociation chamber 54. This embodiment includes the two ion dissociation chambers, and the ion dissociation chamber 54 exists on a line that is located on a different line away from a straight line joining the ion source and the detection system. The introduction of ions into the ion dissociation chamber 54 from the ion source is achieved by deflecting the ions by 90 degrees by use of the quadrupole deflector 52. Thereafter, electrons are introduced into the ion dissociation chamber 54 from an electron source 42. The ECD is performed in the ion dissociation chamber 54. An operation method of accumulating ions in the pre ion trap 4 while either of the two ion dissociation chambers is performing ion dissociation, isolation or ejection is basically the same as the operation method of Embodiment 1.

The ion dissociation chamber 54 is located off the straight line joining the ion source 1 and the detection system. Hence, even when the ion dissociation is being performed in the ion dissociation chamber 54, ions newly coming out of the ion source 1 can travel to and be detected by the TOF mass spectrometers 31 to 33. That is, even while a dissociation operation or a tandem mass spectrometry is being performed in the ion dissociation chamber 54, a full mass spectrum or MS/MS spectra using the ion dissociation chamber 51 can be acquired. In a case where a long time is needed for the ion dissociation in the ion dissociation chamber 54, or when a long time is needed for multiple repetition of a tandem mass spectrometry or the like there, a full mass spectrum or MS/MS spectra using the ion dissociation chamber 51 may be acquired during that time-consuming operation there. Accordingly, an efficient measurement is feasible. In other words, a high-throughput analysis can be achieved.

It is also possible to perform ECD in the ion dissociation chamber 51. The ECD can be carried out when: a permanent magnet is placed in the ion dissociation chamber 51; and electrons from the electron source 42 are deflected by the quadrupole deflector 52, and are thus introduced into the ion dissociation chamber 51.

ETD can be carried out in the ion dissociation chamber 54 when: a negative ion source is used as the source 42; and a quadrupole filter or ion trap is placed between the negative ion source 42 and the ion dissociation chamber 54. ETD can be carried out in the ion dissociation chamber 51 as well. Moreover, IRMPD can be carried out in the ion dissociation chamber 54 when the negative source 42 is replaced with a laser source.

As in the case of Embodiment 1, the detection system suffices if the mass spectrum can be acquired. Furthermore, multipole electrode rods such as hexapole electrode rods or octapole electrode rods may be used for the pre ion trap and the ion dissociation chambers.

### Embodiment 4

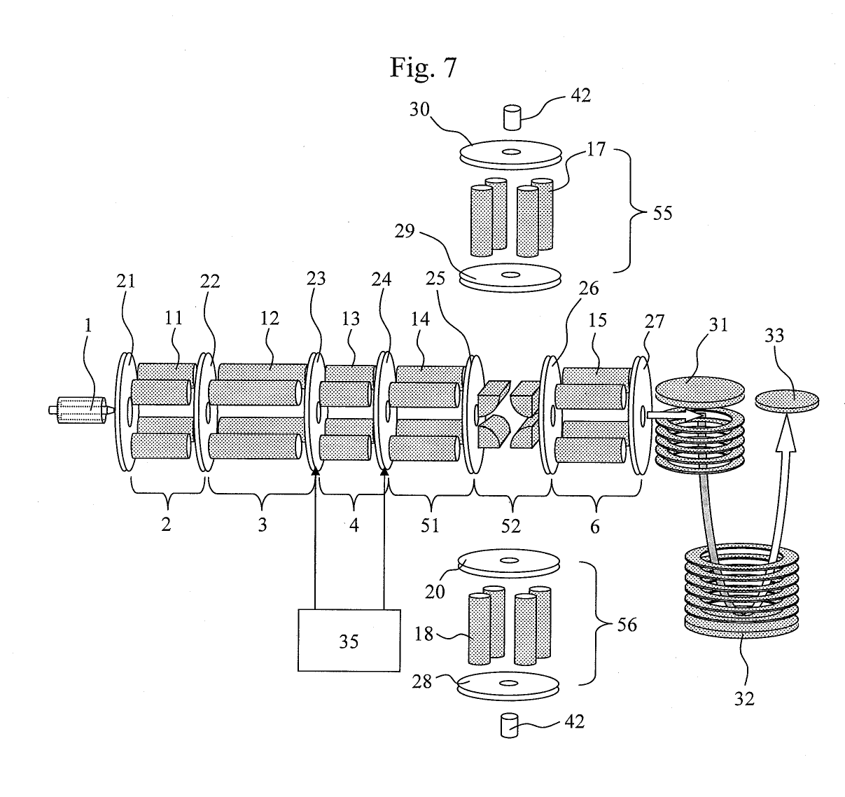

FIG. 7 is a diagram for describing the other embodiment of the mass spectrometer including a quadrupole mass filter 3, a pre ion trap 4, and ion dissociation chambers 51, 55, 56. The mass spectrometer has a configuration including two ion dissociation chambers which are equivalent to the ion dissociation chamber placed on the different line in Embodiment 1. An operation method of accumulating ions in the pre ion trap 4 while ion dissociation, ion isolation or ion ejection is being performed by use of any one of the three ion dissociation chambers is basically the same as the operation method of Embodiment 1. Also, as in the case of Embodiment 3, a full mass spectrum or MS/MS spectra using the ion dissociation chamber 51 can be measured while a dissociation operation or a tandem mass spectrometry is being performed in the ion dissociation chambers 55, 56.

ECD can be carried out when: an electron source is used as the source 42; and a permanent magnet is placed in the ion dissociation chambers 51, 55, 56. ETD can be carried out in the ion dissociation chambers 51, 55, 56 when: a negative ion source is used as the source 42; and a quadrupole filter or ion trap is placed between the negative ion source 42 and the ion dissociation chamber 51, 55, 56. Moreover, IRMPD can be carried out in the ion dissociation chambers 55, 56 when a laser source is used as the source 42.

A configuration including no ion dissociation chamber 51 may be considered. In this case, a full mass spectrum is acquired from the straight line extending straight from the ion source to the detector, and MS/MS spectra are acquired from the ion dissociation chambers 55, 56 situated off that line. The time needed to acquire the full mass spectrum is often shorter than that needed to acquire the MS/MS spectra. Hence, there is an advantage that the full mass spectrum can be always acquired while no ions are present on the straight line, such as while ion dissociation is being performed in the ion dissociation chambers.

As in the case of Embodiment 1, a detection system suffices if the mass spectrum can be acquired. Moreover, multipole electrode rods such as hexapole electrode rods or octapole electrode rods may be used for the pre ion trap 4 and the ion dissociation chamber 5.

### EXPLANATION OF REFERENCE NUMERALS

1 ion source
2 ion guide
3 quadrupole mass filter
4 pre ion trap
5 ion dissociation chamber
6 collisional-damping chamber
11-18 linear quadrupole electrode
20-30 wall electrode
31 accelerator
32 reflectron
33 detector
34 electron source
35 controller
41 permanent magnet
42 electron source, positive/negative ion source, or laser source
51 ion dissociation chamber
52 quadrupole deflector (deflector)
53 ion guide
54-56 ion dissociation chamber
57 quadrupole mass filter or ion trap

1. A mass spectrometer characterized by comprising:
an ion source for ionizing a sample;
a mass filter, disposed at a stage following the ion source, for selectively transmitting ions falling within a specific mass number range;
an ion trap unit, disposed at a stage following the mass filter, for accumulating ions;
an ion dissociation unit, disposed at a stage following the ion trap unit, for accumulating ions and dissociating the ions thus accumulated;
a detection unit, disposed at a stage following the ion dissociation unit, for detecting ions; and
a controller for controlling the ion accumulation and ion ejection in the ion trap unit in accordance with an operation of the ion dissociation unit.

2. The mass spectrometer of claim 1, characterized in that
the controller causes the ion trap unit to accumulate ions passed through the mass filter except while the ion dissociation unit is accumulating the ions.

3. The mass spectrometer of claim 1,
characterized by further comprising an electrode for controlling entry of ions into the ion dissociation unit,
characterized in that the controller causes the ion trap unit to accumulate the ions passed through the mass filter while the controller is applying a voltage to the electrode to block the entry of ions into the ion dissociation unit.

4. The mass spectrometer of claim 1, characterized by further comprising a quadrupole deflector at a stage preceding or following the ion dissociation unit,
characterized in that the ion trap unit, the detection unit, and any one of an electron source and a negative ion source are provided at a first opening side, a second opening side, and a third opening side of the quadrupole deflector, respectively.

5. The mass spectrometer of claim 4, characterized in that
a second ion dissociation unit is disposed between the quadrupole deflector and any one of the electron source and the negative ion source.

6. The mass spectrometer of claim 1,
characterized by further comprising an electron source,
characterized in that the ion dissociation unit dissociates the ions through an electron capture dissociation reaction between the ions and electrons generated by the electron source.

7. The mass spectrometer of claim 1,
characterized by further comprising a negative ion source,
characterized in that the ion dissociation unit dissociates the ions through an electron transfer dissociation reaction between the ions and negative ions generated by the negative ion source.

8. The mass spectrometer of claim 1, characterized in that
the detection unit is any one of a time-of-flight mass spectrometer, an ion trap, a mass filter, an orbitrap, a Fourier-transform ion cyclotron resonance mass spectrometer, and a magnetic sector mass spectrometer.

9. A method of mass spectrometry characterized by comprising the steps of:
ionizing a sample;
selecting first ions having a specific mass number range from the ions thus generated;
accumulating the selected first ions in an ion dissociation unit;
dissociating the first ions in the ion dissociation unit, and accumulating second ions having a specific mass number range in an ion trap unit provided at a stage preceding the ion dissociation unit;
ejecting fragment ions generated by dissociating the first ions;
detecting the ejected fragment ions, and accumulating the second ions, accumulated in the ion trap unit, in the ion dissociation unit;
ejecting fragment ions generated by dissociating the second ions; and
detecting the ejected fragment ions.

10. The method of mass spectrometry of claim 9, characterized in that
the dissociation unit dissociates the ions through collision induced dissociation.

11. The method of mass spectrometry of claim 9, characterized in that
The dissociation unit dissociates the ions through electron capture dissociation.

12. The method of mass spectrometry of claim 9, characterized in that
the dissociation unit dissociates the ions through electron transfer dissociation.

13. The mass spectrometer of claim 1, characterized in that
the dissociation unit is any one of an ion trap and a travelling wave.
